(19) United States
(12) Patent Application Publication
(10) Pub. No.: US 2004/0114194 A1
(43) Pub. Date: Jun. 17, 2004

(54) Facsimile machine

(75) Inventors: Masashi Eguchi, Joyo-shi (JP); Yoshifumi Tanimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Murata Kikai Kabushiki Kaisha, Kyoto-shi (JP)

(21) Appl. No.: 10/730,097

(22) Filed: Dec. 9, 2003

(30) Foreign Application Priority Data
Dec. 11, 2002 (JP) 2002-359892
Dec. 11, 2002 (JP) 2002-359891
Dec. 11, 2002 (JP) 2002-359890

(51) Int. Cl. H04N 1/00

(52) U.S. Cl. 358/400; 358/402

(57) ABSTRACT

A facsimile machine which can reduce a period of time from a transmission operation of an original document until the end of the transmission. The facsimile machine executes a parallel process of a process for accepting a start command of the process, a scanning/encoding process, a dividing process, an electronic mail generating process, and an electronic mail transmitting process.

### FIELD OF THE INVENTION

The present invention relates to a facsimile machine, and more specifically to an Internet facsimile machine which can transmit image data as electronic mail via a communication network such as the Internet or a Local Area Network LAN).

### DESCRIPTION OF THE RELATED ART

Recently, various networks that have been constructed independently are connected with one another to form a large scaled network (hereinafter referred to as the “Internet”), and the Internet is used in various fields. In contrast with a telephone network or the like, by using the Internet, communication can be carried out with computers in another country, not only computers in the same county, just by paying costs for establishing a connection with the Internet. Therefore, an Internet facsimile machine (hereinafter referred to as the “facsimile machine”) that reduces communication costs by distributing electronic mail attached with image data via the Internet is being put into practical use.

There are various restrictions on the transmission of electronic mail. One example of these restrictions is that the data size of the electronic mail is restricted. Therefore, when the image data of a transmission of an original document is large and the electronic mail exceeds the permissible data size, even if the electronic mail is transmitted, the electronic mail is rejected from being forwarded. As a result, the electronic mail is not received by a destination device.

Therefore, when an amount of the image data of the transmission of an original document exceeds an amount of data defined for one electronic mail, a facsimile machine may divide the image data and transmit the divided image data by a plurality of electronic mails. As a result, even when the amount of the image data is large, the image data can be transmitted by the electronic mail.

However, such a facsimile machine had the problem that it required a long period of time from the start of scanning of an original document until the end of the transmission of the image data. This was due to the fact that until the completion of scanning of all original documents and encoding of the image data, it was necessary to suspend the process for dividing the encoded image data and the process for transmitting the divided image data by electronic mail.

### SUMMARY OF THE INVENTION

The present invention was made in consideration of such a problem. An advantage of the present invention is to provide a facsimile machine which scans an original document, and each time an amount of the scanned image data exceeds a prescribed amount, in parallel with the scanning process of the original document, the facsimile machine divides the scanned image data and transmits each divided image data by electronic mail. By carrying out a parallel process of the scanning process of the original document and the process of attaching each image data to electronic mail and transmitting the electronic mails, the facsimile machine can reduce a period of time from the transmission operation of the original document until the completion of the transmission of the electronic mails.

An advantage of the present invention is to provide a facsimile machine which by establishing communication with a remote device (for example, a mail server or a destination device) when the scanning process of the original document is started, carries out a parallel process of a scanning process of an original document and a process of establishing communication with the remote device. In addition, by maintaining the connection with the remote device until all electronic mails are transmitted, the facsimile machine can eliminate the process of establishing the communication with the remote device each time each electronic mail is transmitted.

An advantage of the present invention is to provide a facsimile machine which stores the electronic mail in a storage unit, and when it is determined that the remote device received the electronic mail, the facsimile machine erases the electronic mail from the storage unit. Thus, the facsimile machine of the present invention can increase available capacity in the storage unit.

An advantage of the present invention is to provide a facsimile machine which scans an original document, and each time an amount of the scanned image data exceeds a prescribed amount, in parallel with the scanning process of the original document, the facsimile machine divides the scanned image data and transmits each divided image data by separate electronic mails. The facsimile machine can reduce a period of time from the scanning operation of the original document until the transmission of the electronic mails. In addition, the facsimile machine of the present invention can prevent an unnecessary process to be carried out by stopping the transmission of the electronic mail when an error generates in the scanning of the original document or by stopping the scanning of the original document when an error generates in the transmission of the electronic mail.

An advantage of the present invention is to provide a facsimile machine which when detecting an error in the transmitted electronic mail, by providing electronic mail with management information of the electronic mail with the error and retransmitting the electronic mail, information of the electronic mail which became an error can be determined at the receiving device.

An advantage of the present invention is to provide a facsimile machine which stores the electronic mail in the storage unit, and when it is determined that the electronic mail can be retransmitted based on the contents of the error, the facsimile machine of the present invention outputs the electronic mail from the storage unit and retransmits the electronic mail so that the burden on a user can be reduced.

An advantage of the present invention is to provide a facsimile machine which when it is determined that the electronic mail cannot be retransmitted based on the contents of the error, stops the scanning process of the original document and the transmission process of the electronic mail to prevent an unnecessary process to be executed.

An advantage of the present invention is to provide a facsimile machine which scans an original document, and each time an amount of the scanned image data exceeds a prescribed amount, in parallel with the scanning process of the original document, the facsimile machine divides the scanned image data and transmits each divided image data by separate electronic mails. The facsimile machine can reduce a period of time from the scanning operation of the original document until the completion of the transmission of the electronic mails. In addition, the facsimile machine of the present invention provides electronic mail with management information indicating a transmission number of the electronic mail to be transmitted and transmits the electronic mail to facilitate the management of the electronic mail at the receiving device.

An advantage of the present invention is to provide a facsimile machine which provides electronic mail with management information indicating whether or not subsequent electronic mail will be transmitted and provides electronic mail with management information indicating a total number of electronic mails to facilitate the management of the electronic mail at the receiving device.

An advantage of the present invention is to provide a facsimile machine which provides electronic mail with management information indicating page information of the original document to facilitate the management of the image data attached to the electronic mail and the restoration of the image of the original document at the receiving device.

According to the present invention, the facsimile machine scans an original document, and each time the amount of the scanned image data exceeds a prescribed amount, in parallel with the scanning process of the original document, the facsimile machine divides the scanned image data and transmits each divided image data by the electronic mail. Since the facsimile machine can carry out the parallel process of the scanning process of the original document and the transmitting process of each image data by the electronic mail, the period of time from the start of the scanning process of the original document until the end of the transmission of the image data can be reduced.

Moreover, the facsimile machine can reduce an amount of electronic mail to be transmitted by dividing the scanned image data, attaching each divided image data to separate electronic mails and transmitting the electronic mails. Therefore, even if the remote device has a restriction on the amount of data of the electronic mail, the image data can be transmitted stably to the target remote device without the reception of the electronic mails being rejected.

Furthermore, by establishing the communication with the remote device at the start of the scanning process of the original document, the facsimile machine can execute the parallel process of the scanning process of the original document and the process of establishing the communication with the remote device. Therefore, the period of time from the start of the scanning process of the original document until the end of the transmission of the image data can be reduced even more.

In addition, until all electronic mails are transmitted, the facsimile machine maintains the connection with the remote device. Therefore, the process of establishing the communication with the remote device each time each electronic mail is transmitted becomes unnecessary, and the period of time from the start of the scanning process of the original document until the end of the transmission of the image data can be reduced even more.

Moreover, the facsimile machine stores the electronic mail in the storage unit, and when it is determined that the remote device received the electronic mail, the facsimile machine erases the electronic mail from the storage unit. As a result, there are beneficial effects such as an increase in the available capacity of the storage unit. Moreover, when the SMTP is used, if the transmission of the electronic mail is interrupted, the electronic mail transmitted in advance within the same session can be destroyed retroactively.

Furthermore, when an error generates in the scanning of the original document, the facsimile machine stops the transmission of the electronic mail, and when an error generates in the transmission of the electronic mail, the facsimile machine stops the scanning of the original document. As a result, unnecessary process is prevented from being carried out.

Moreover, when detecting an error in the transmitted electronic mail, the facsimile machine provides electronic mail with the management information of the electronic mail with the error and retransmits the electronic mail. As a result, the information of the electronic mail which became an error can be determined by the receiving device.

In addition, the facsimile machine stores the electronic mail in the storage unit, and when it is determined that the electronic mail can be retransmitted based on the contents of the error, the facsimile machine outputs the electronic mail from the storage unit and retransmits the electronic mail. As a result, the burden placed on the user can be reduced.

Moreover, when it is determined that the electronic mail cannot be retransmitted based on the contents of the error, the facsimile machine stops the scanning of the original document and the transmission of the electronic mail. As a result, there are beneficial effects that, for example, unnecessary process can be prevented from being executed in case of the error that prohibits the retransmission of the electronic mail.

Furthermore, as the management information, the facsimile machine provides the electronic mail with the information indicating the transmission number of the electronic mail, the information indicating whether or not subsequent electronic mail will be transmitted, the information indicating the total number of the electronic mails and/or the page information of the original document. Then, the facsimile machine transmits the electronic mail. As a result, there are beneficial effects such as the facilitation of the management information of the electronic mail at the receiving device, that is, the management of the image data and the restoration of the image of the original document.

### BRIEF DESCRIPTION OF THE DRAWINGS

FIG. 1 is a schematic diagram showing a configuration of a communication network connected with a facsimile machine according to the present invention.

FIG. 2 is a block diagram showing a configuration of a facsimile machine according to the present invention.

FIG. 3 shows an example of contents of an electronic mail.

FIG. 4 is a flowchart showing a process protocol carried out by a facsimile machine according to a first embodiment of the present invention.

FIG. 5 shows an example of contents of a table.

FIGS. 6A and 6B are flowcharts showing a process protocol of an interruption process carried out by a facsimile machine according to the first embodiment of the present invention.

FIG. 7 is a flowchart showing a process protocol of an interruption process carried out by a facsimile machine according to the first embodiment of the present invention.

FIG. 8 shows an example of contents of management information to be added to electronic mail.

FIG. 9 shows operation timings of a facsimile machine according to the first embodiment of the present invention.

FIG. 10 is a flowchart showing a process protocol carried out by a facsimile machine according to a second embodiment of the present invention.

FIG. 11 shows operation timings of a facsimile machine according to the second embodiment of the present invention.

FIG. 12 shows operation timings of a facsimile machine in another example of a dividing process.

### DETAILED DESCRIPTION OF PREFERRED EMBODIMENTS

Embodiments of the present invention will be described with reference to the drawings.

(First Embodiment)

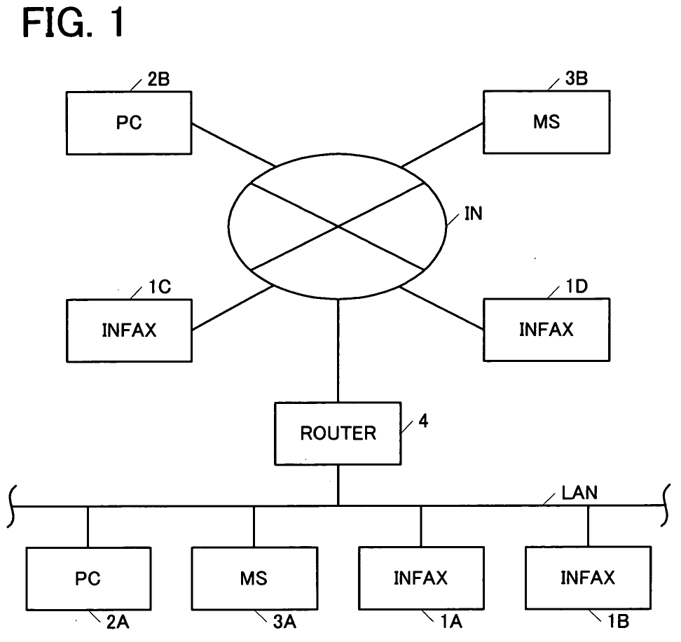

FIG. 1 is a schematic diagram showing a configuration of a communication network connected with an Internet facsimile machine which is an example of a facsimile machine of the present invention. Reference numerals 1A, 1B, 1C and 1D denote a facsimile machine according to the present invention (hereinafter referred to as “INFAX”). Further, the INFAX 1A, 1B, 1C and 1D (when it is not necessary to distinguish each INFAX, the INFAX 1A, 1B, 1C and 1D will be collectively referred to as “INFAX 1”) can be used as a conventional G3 facsimile machine using a Public Switched Telephone Network (PSTN) Thus, the connection between the INFAX 1 and the PSTN is omitted in the drawing.

The INFAX 1A and 1B, a Mail Server (MS) 3A, a Personal Computer (PC) 2A or the like are connected to a Local Area Network (LAN), and these devices (the INFAX 1A and 1B, the PC 2A) can carry out communication (transmission and reception) with one another using electronic mail via the MS 3A. Moreover, the LAN is connected to the Internet IN via a router 4, and the INFAX 1C and 1D, a MS 3B, a PC 2B or the like are connected to the Internet IN. These devices (the INFAX 1C and 1D, the PC 2B, etc.) can carry out communication with one another using electronic mail via the MS 3B. Furthermore, each of the devices connected to the LAN and each of the devices connected to the Internet IN can carry out communication with one another using electronic mail via the MS 3A and 3B and the router 4. The INFAX 1 transmits and receives electronic mail by a Simple Mail Transfer Protocol (SMTP). A Post Office Protocol (POP) can be used for the reception, but it is preferable to use the SMTP.

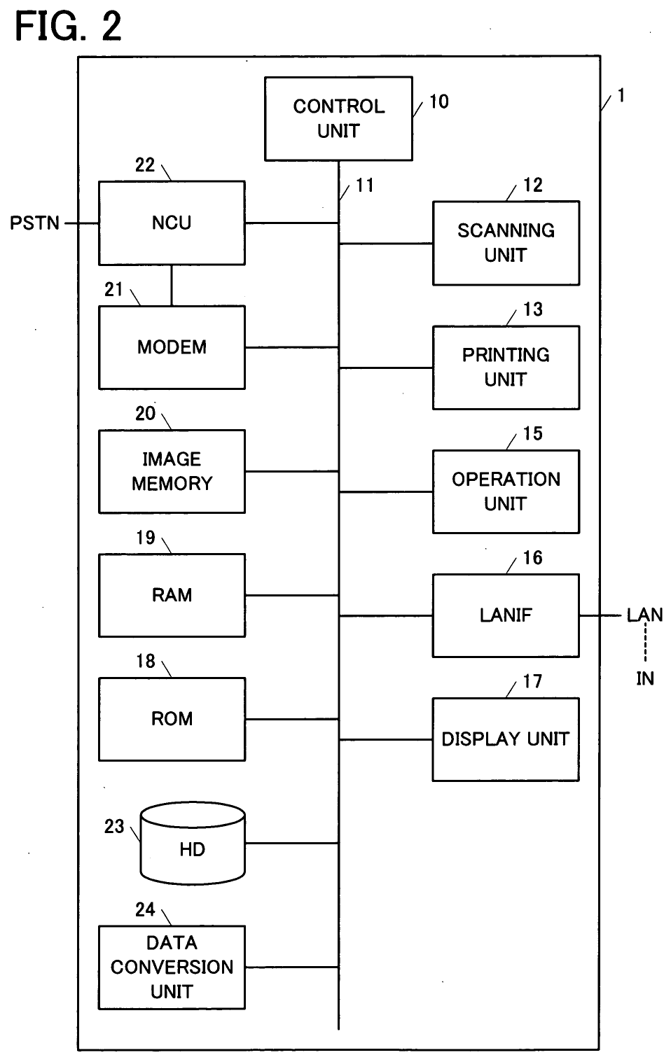

FIG. 2 is a block diagram showing a configuration of a facsimile machine according to the present invention. The INFAX 1, which is an example of a facsimile machine according to the present invention, includes a control unit 10 formed from a Central Processing Unit (CPU). The control unit 10 is connected to a scanning unit 12, a printing unit 13, an operation unit 15, a LAN interface (LANIF) 16, a display unit 17, a Read Only Memory (ROM) 18, a Random Access Memory (RAM) 19, an image memory 20, a modem 21, a Network Control Unit (NCU) 22, a Hard Disk (HD) 23 and a data conversion unit 24 via a bus 11. The control unit 10 controls each of the units, and executes various functions in accordance with computer program stored in the ROM 18 in advance. The control unit 10 executes various functions (a scanning/encoding function, an electronic mail data amount detecting function, a dividing function, an electronic mail generating function, a communication connecting function, an electronic mail transmitting function, an electronic mail storing function, a communication disconnecting function, etc.) in cooperation with another unit or independently.

The scanning unit 12 executes the scanning/encoding function to carry out a scanning/encoding process with the control unit 10. The scanning unit 12 scans a transmission of an original document by a scanner using a Charge Coupled Device (CCD) or the like. Then, for example, the scanning unit 12 converts the scanned data into a binary of black and white by a Coder and Decoder (CODEC) (not shown), and generates and outputs the encoded image data (encoded data). The encoded image data is stored into the image memory 20 via the bus 11. Further, the image memory 20 is formed from a Dynamic Random Access Memory (DRAM) or the like. As the encoding method, the encoding methods such as Modified Huffman (MH) which is a one-dimensional encoding method, Modified READ (MR) which is a two-dimensional encoding method, and Modified Modified READ (MMR) which is a partial improvement of the MR, are defined by a standard of facsimile communication. Further, an encoding unit such as the CODEC can be provided separately from the scanning unit 12, and the encoding process can be carried out.

The printing unit 13 is an electro-photographic typed printing device or the like. The printing unit 13 prints out as hardcopy, image data received from another facsimile machine by facsimile communication or image data received by a communication network. Either one of an Automatic Document Feeder (ADF) method or a Flat Bed Scanner (FBS) method can be used as the scanning method for scanning an original document.

The operation unit 15 includes various letter keys, a ten-key numeric pad, speed-dial keys, one-touch dial keys, and various function keys or the like that are necessary for operating the INFAX 1. The operation unit 15 also functions as an input unit. Further, by forming the display unit 17 as a touch panel, a part or all of the various keys of the operation unit 15 can be substituted.

The LANIF 16 is an interface for the INFAX 1 (for example, the INFAX 1A) to carry out communication with another INFAX 1 (1B), the PC (2A) and the MS (3A) via the LAN. The LANIF 16 can execute the communication connecting function, the electronic mail transmitting function and the communication disconnecting function with the control unit 10 when carrying out the electronic mail transmitting process. Moreover, the LANIF 16 is connected to the Internet IN via the router 4, and can carry out communication with another INFAX 1 (1C, 1D), the PC (2B) and the MS (3B).

The display unit 17 is a displaying device such as a Liquid Crystal Display (LCD). The display unit 17 displays an operation status of the INFAX 1 and also displays image data of a transmission original document, received image data or the like.

The RAM 19 stores temporary data that generates when the computer program is executed by the control unit 10. For example, the RAM 19 is formed from a DRAM, a flash memory or the like.

The modem 21 is formed from a facsimile modem which can carry out facsimile communication. The NCU 22 is connected directly to the modem 21. The NCU 22 establishes and disconnects a connection with the PSTN. When necessary, the NCU 22 connects the modem 21 to the PSTN, and controls the facsimile communication between the INFAX 1 and a remote facsimile machine (a conventional facsimile machine which does not use electronic mail).

The data conversion unit 24 executes the dividing process function to carry out the dividing process with the control unit 10. The data conversion unit 24 monitors an amount of the image data of the original document (encoded data) encoded in accordance with the above-described facsimile machine standard. Each time the amount of data exceeds a prescribed amount, the data conversion unit 24 divides the image data (encoded data), and converts the divided image data (encoded data) into an image format of a Tagged Image File Format (TIFF) or a Portable Document Format (PDF) so that the image data can be transmitted using electronic mail. When transmitting the image data, the TIFF image format is converted (encoded) from binary data into text data by using the Multipurpose Internet Mail Extensions (MIME) base 64. Further, when receiving the image data, a converting process (decoding) that is the opposite of the converting process carried out at the transmission can be carried out.

Moreover, the data conversion unit 24 executes the electronic mail generating function to carry out the electronic mail generating process with the control unit 10. When transmitting electronic mail, the data conversion unit 24 generates electronic mail that includes an electronic mail header (hereinafter referred to as a “header”) and image data (TIFF data) that is converted in text data. Further, the header includes information such as a transmission date and time of the electronic mail, a transmitter of the electronic mail, a destination of the electronic mail and additional information of the electronic mail.

The HD 23 is a memory having a large capacity, and appropriately stores image data, an electronic mail address, a facsimile number, a name of a destination, a facsimile number corresponding to a speed-dial key, and a telephone directory or the like. Moreover, the HD 23 executes the electronic mail storing function to carry out the electronic mail storing process with the control unit 10. The HD 23 stores the electronic mail transmitted in the electronic mail generating process. In addition, the HD 23 receives information of whether or not a remote device received the transmitted electronic mail. When it is determined that the remote device received the electronic mail, or when a prescribed period of time elapses after the electronic mail is stored in the HD 23, the electronic mail stored in the HD 23 is erased. Accordingly, the electronic mail received by the remote device, in other words, the electronic mail that is not necessary to be stored, is erased, and the available capacity in the HD 23 can be increased.

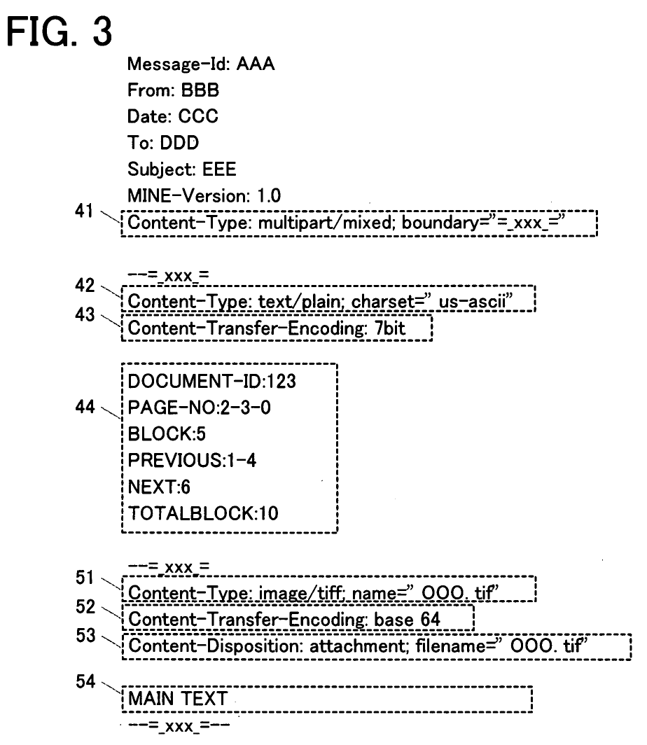

Next, the contents of the electronic mail generated by the data conversion unit 24 will be described in detail. FIG. 3 shows an example of the contents of an electronic mail. The header includes “field name”, “:” and “field contents”, and in some fields, the field is delimited by “;” and provided with detailed information by a parameter consisting of “parameter name”, “=” and “parameter contents”.

In the header, a field 41 is a field extended by the MIME, and indicates that the main text is divided into a plurality of components. The parameter delimited by “;” (boundary=) shows delimiter information of each of the divided components. That is, “--=_xxx_” of the main text shows the start of each of the components, and “--=_xxx=--” shows the end of the components. Further, each of the divided components has a format of “header”, “blank line” and “main text” respectively.

The first component includes management information of the electronic mail. A field 42 indicates that the main text is data in a text format, and by the parameter delimited by “;” (charset=), indicates that the character code is “us-ascii”. A field 43 indicates the data conversion format of the main body, but a field name “7 bit” indicates 7 bit data without encoding.

A blank line is inserted between the field 43 and a first main text 44. In the first main text 44, the management information of the electronic mail is provided by the character code “us-ascii”. The management information consists of “DOCUMENT-ID” which indicates an identification number of the original document (document), “PAGE-NO” which indicates page information of the original document, “BLOCK” which indicates a transmission number of the electronic mail, in other words, an order of the electronic mail among the transmission electronic mails, “NEXT” which indicates a transmission number of electronic mail to be transmitted next, and “TOTALBLOCK” which indicates a total number of electronic mails planned to be transmitted. Here, “PAGE-NO” consists of three information, a page number of the original document, a number which indicates an order of the data in that page, and a flag which indicates whether the data is the last data of that page. For example, it can be defined that a flag “0” to be applied when the data is the last data of that page, and a flag “1” to be applied when the data is not the last data. In the example shown in FIG. 3, the management information “PAGE-NO” is “2-3-0”. That is, the “3”rd data of the “2”nd page of the original documents is attached to the electronic mail, and since the flag is “0”, the “2”nd page of the original documents is divided into “3” data and transmitted. Further, the management information “TOTALBLOCK” can be provided as information when the scanning/encoding process for all original documents has been completed. When the scanning/encoding process is not completed yet, dummy information such as a null character or “−99” defined in advance can be provided as the management information “TOTALBLOCK”.

The next component consists of image data attached to the electronic mail and information of the image data. A field 51 is a filed extended by the MIME, and indicates that the main text is TIFF image data. The information of the file name is indicated by a parameter (name=) delimited by “;”. A field 52 indicates that a conversion (binary/text conversion) format of the data is the MIME (base 64). A field 53 indicates that a disposition method of the data is an attached file, and a parameter (filename=) delimited by “;” indicates the information of the file name.

A blank line in inserted after the field 53, and in a second main text 54, the TIFF data converted from binary data into text data by the MIME (base 64) is provided.

Further, when determining whether or not the remote device received the transmitted electronic mail, for example, a field of “Disposition-Notification-To: (own electronic mail address)” is added to the header of the electronic mail shown in FIG. 3, and the electronic mail is transmitted. Then, when the receiving device receives the electronic mail, the receiving device may return electronic mail indicating the reception.

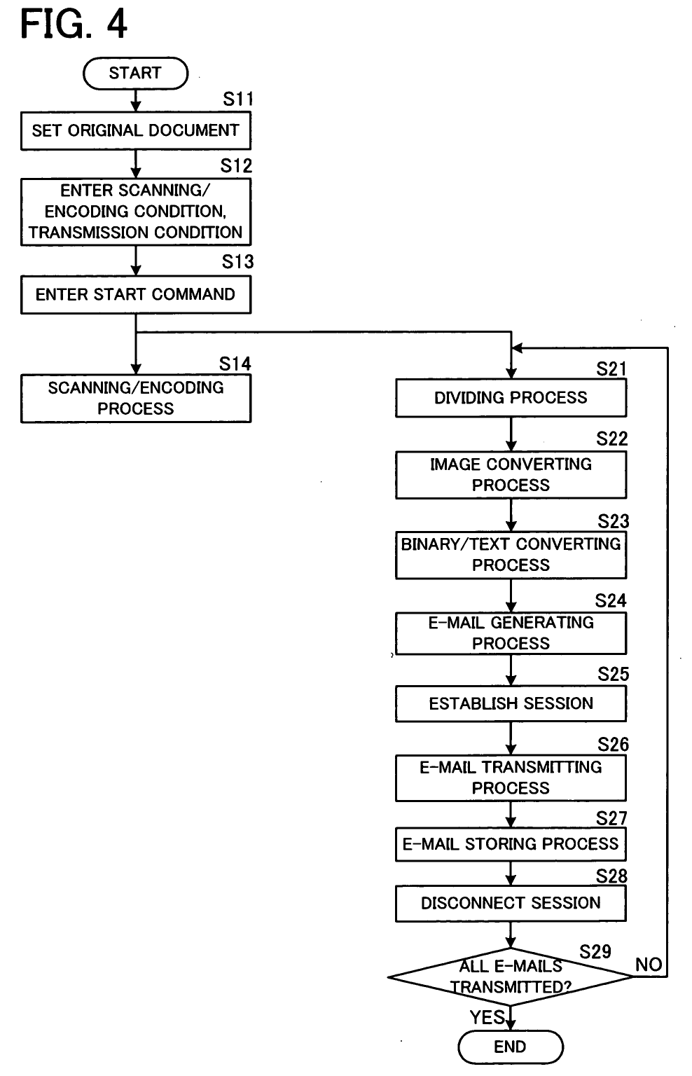

Next, the operation of the facsimile machine according to the first embodiment will be described with reference to FIG. 4. FIG. 4 is a flowchart showing a process protocol carried out by the facsimile machine according to the first embodiment of the present invention.

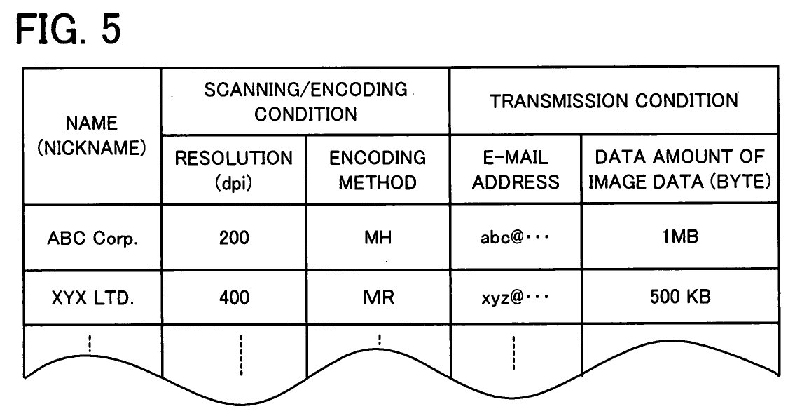

A user provides an original document table of the ADF or the FBS with an original document to be transmitted (step S11). In addition, a scanning/encoding condition and a transmission condition are entered from the operation unit 15 (step S12). Further, the scanning/encoding condition includes the resolution and the encoding method or the like of the scanning unit 12. The transmission condition includes an electronic mail address of the destination and a prescribed amount that defines the amount of the image data to be attached to one electronic mail. Furthermore, when a start command of the process is entered from the operation unit 15 (step S13), the INFAX 1 carries out a parallel process of a scanning/encoding process, and a dividing process, a communication connecting process, an electronic mail generating process (including image converting process and binary/text converting process), an electronic mail transmitting process and a communication disconnecting process. Further, in step S12, the scanning/encoding condition and the transmission condition are not entered respectively by the user. A name of the destination device, such as a nickname, that is associated with the scanning/encoding condition and the transmission condition can be registered in the HD 23 as a table (an example is shown in FIG. 5), and the name can be selected. Moreover, when transmitting and receiving the data with the destination device, it is preferable to receive the information of the receiving ability or the like of the destination and to update the table automatically.

Then, when the INFAX 1 receives the start command of the process in step S13, the scanning/encoding process is executed (step S14). That is, in case of the ADF, the original documents placed on the original document table is fed one sheet at a time, and in accordance with the scanning/encoding condition entered in step S12, the original document is scanned by the CCD of the scanning unit 12. Then, the image data encoded by the encoding method, such as the MH, the MR or the MMR, is stored in the image memory 20.

Meanwhile, in parallel with the scanning/encoding process (step S14), the INFAX 1 executes a dividing process (step S21). In the dividing process, the INFAX 1 accesses the image memory 20, calculates the amount of the image data of the stored original document, and each time when the calculated amount exceeds a prescribed amount, the INFAX 1 divides the image data. Then, an image converting process (step S22) is executed for converting the divided image data into TIFF data. Furthermore, the binary/text converting process (step S23) is executed for converting the TIFF data (binary data) into text data by the MIME (base 64).

Then, the electronic mail generating process (step S24) is executed. In the electronic mail generating process, the information indicating that the transmission data is the TIFF data and the information indicating that the data has been converted from binary data into text data by the MIME (base 64) are added to the header of the electronic mail, and the text data converted in step S23 is added to the electronic mail.

Next, a Transmission Control Protocol (TCP) session is established with a remote device (a mail server or a destination device) (step S25). There are cases where a device, which is the destination of the electronic mail, becomes the remote device, and where a general electronic mail server becomes the remote device. Then, an electronic mail transmitting process (step S26) is executed for transmitting the electronic mail by the SMTP. When the transmitting process is completed, an electronic mail storing process (step S27) is executed for storing the transmitted electronic mail in the HD 23, and the TCP session established between the INFAX 1 and the remote device is disconnected (step S28). That is, step S25 corresponds to the communication connecting process and step S28 corresponds to the communication disconnecting process.

Then, it is determined whether or not all electronic mails have been transmitted (step S29). When it is determined that all electronic mails have not been transmitted (step S29: NO), the process proceeds to step S21, and the processes of steps S21 through S29 are executed. Meanwhile, when it is determined that all electronic mails have been transmitted (step S29: YES), the process is ended.

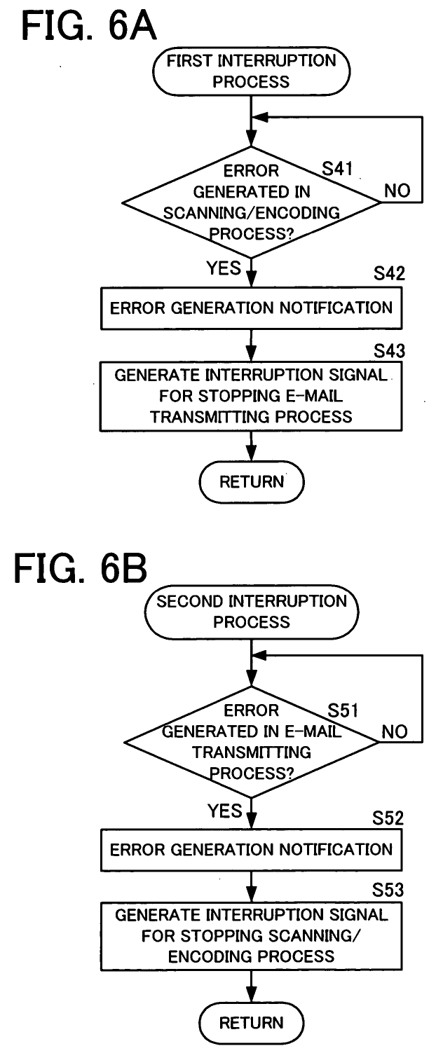

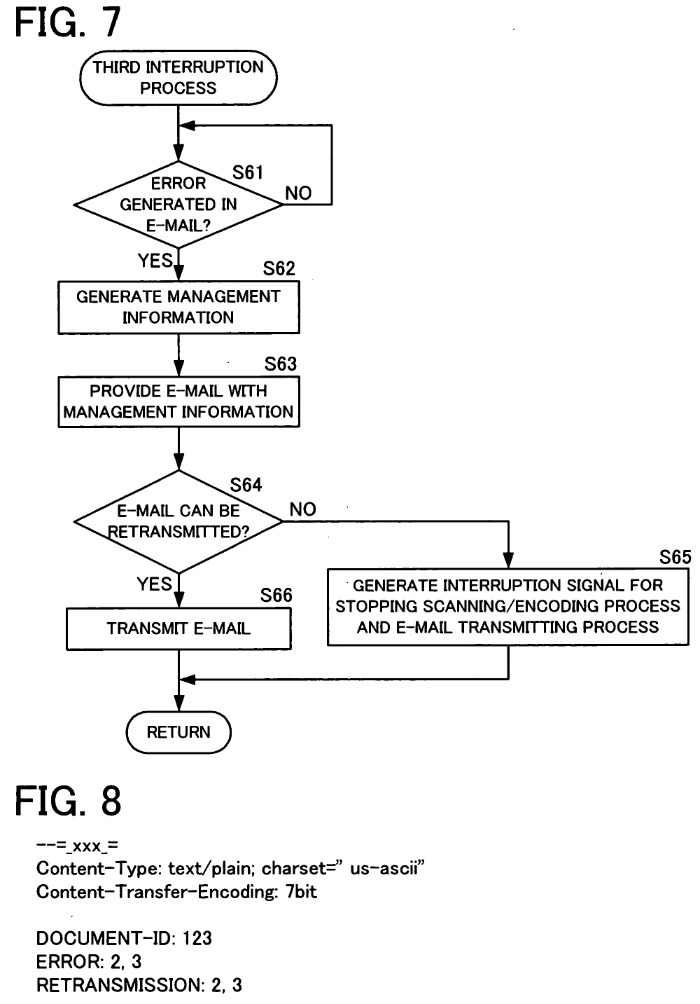

In addition, the facsimile machine according to the present invention is also capable of monitoring various errors, and when an error is detected during the process protocol, the following interruption process is executed. FIGS. 6A, 6B and 7 are flowcharts showing the interruption process carried out by the facsimile machine according to the first embodiment of the present invention.

The INFAX 1 monitors whether or not an error is generated in the scanning/encoding process (step S41). When an error is detected in the scanning/encoding process (step S41: YES), the generation of the error in the scanning/encoding process is notified (step S42). Then, an interruption signal for stopping the electronic mail transmitting process is generated (step S43), and the process is ended (first interruption process: FIG. 6A).

Moreover, the INFAX 1 monitors whether or not an error is generated in the electronic mail transmitting process (step S51). When an error is detected in the electronic mail transmitting process (step S51: YES), the generation of the error in the electronic mail transmitting process is notified (step S52). Then, an interruption signal for stopping the scanning/encoding process is generated (step S53), and the process is ended (second interruption process: FIG. 6B).

Furthermore, the INFAX 1 monitors whether or not an error is generated in the transmitted electronic mail by receiving an error notification mail or a delivery confirmation mail or the like regarding the transmitted electronic mail (step S61). Then, when an error is detected in the electronic mail (step S61: YES), in accordance with the contents of the error, management information for the electronic mail is generated (step S62), and the generated management information is provided with the electronic mail (step S63).

Then, it is determined whether or not the electronic mail with the error can be retransmitted (step S64). For example, when detecting a character string of “Host unknown” or “User unknown” from the error notification mail, it can be assumed that the error is due to an error in the entered electronic mail address of the destination, which is the transmission condition entered in step S12. Therefore, it is determined that an error will generate again even if the electronic mail is retransmitted. In other words, it is determined that the electronic mail cannot be retransmitted. When it is determined in step S64 that the electronic mail cannot be retransmitted (step S64: NO), an interruption signal is generated (step S65) for stopping the scanning/encoding process and the electronic mail transmitting process, and the process is ended. Meanwhile, when it is determined that the electronic mail can be retransmitted (step S64: YES), the character string is extracted from the “Message-Id” field of the electronic mail with the error. Then, the INFAX 1 accesses to the HD 23, and outputs the electronic mail which has the extracted character string in the “Message-Id”. The electronic mail is retransmitted by the electronic mail transmitting process (step S66), and the process is ended (third interruption process: FIG. 7).

Here, the management information of the electronic mail generated in step S62 will be described. FIG. 8 shows an example of the contents of the management information to be added to the electronic mail. The management information to be added is described by the character code “us-ascii”, and includes “DOCUMENT-ID” which indicates an identification number of the original document (document), “ERROR” which indicates a transmission number of the electronic mail with the error, and “RETRANSMISSION” which indicates a transmission number of the electronic mail planned to be retransmitted. The management information is added to the electronic mail generated in the electronic mail generating process.

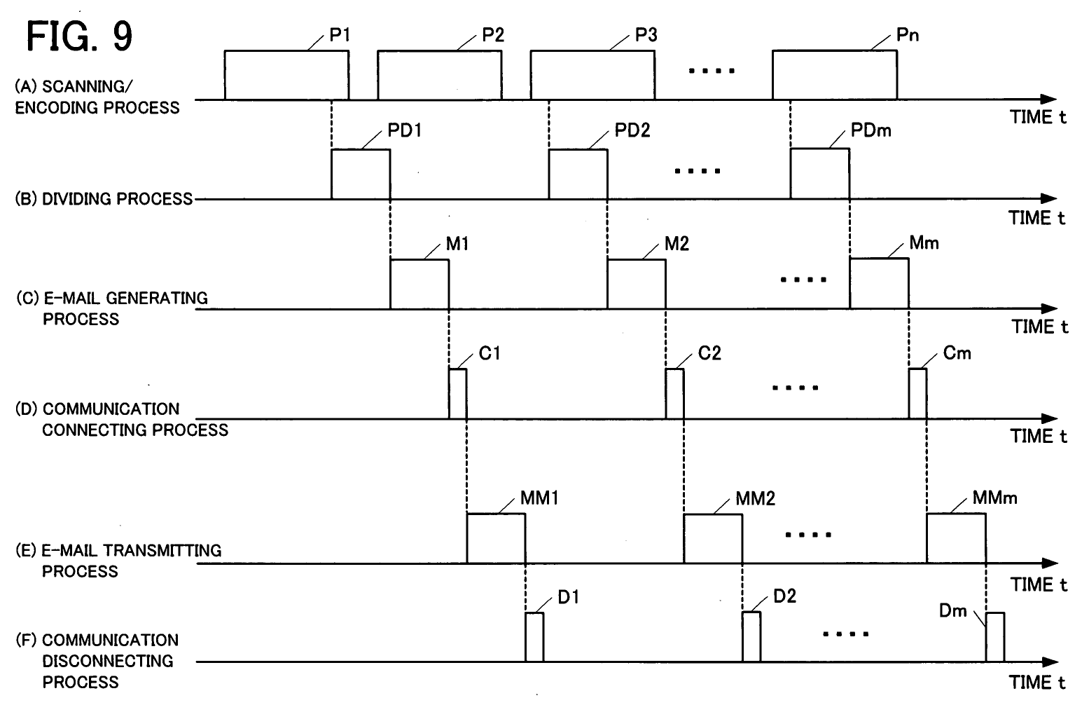

Next, the operation timings of the facsimile machine according to the first embodiment will be described. FIG. 9 shows the state of the operation timings of the facsimile machine according to the first embodiment of the present invention. The horizontal axes indicate an elapse of time. In FIG. 9, (A) shows a state of the scanning/encoding process of the scanning unit 12, (B) shows a state of the dividing process, (C) shows a state of the electronic mail generating process, (D) shows a state of the communication connecting process, (E) shows a state of the electronic mail transmitting process, and (F) shows a state of the communication disconnecting process.

When receiving a start command for transmitting the original document, the control unit 10 controls the operation of the scanning unit 12. The scanning unit 12 executes the scanning/encoding process to scan the original documents consisting of “n” pages by the scanner under the ADF method sequentially from a first page P1 until completing the scanning process of a n-th page Pn which is the last page of the original documents (FIG. 9(A)). In FIG. 9, the time between the scanning/encoding process of each page indicates the time required for feeding the original document by the ADF method.

Moreover, in parallel with the scanning/encoding process, each time the amount of the image data (encoded data) scanned in the scanning/encoding process exceeds the prescribed amount defined in advance, the dividing process is executed to divide the image data into image data PD1 (PD2, . . . , PDm). In FIG. 9, reference numerals PD1, PD2, . . . , and PDm show the image data (divided state) divided first, second, . . . , and m-th respectively.

Then, when the image data is divided into the image data PD1 (PD2, . . . , PDm) in the dividing process, the image converting process, the binary-text converting process, and the electronic mail generating process are executed (FIG. 9(C)). Further, in the image converting process, the image data PD1 (PD2, . . . , PDm) is converted into TIFF data. In the binary/text converting process, the TIFF data is converted into text data. In the electronic mail generating process, a header is generated and the image data converted into the text data is attached to electronic mail, and the electronic mail M1 (M2, . . . , Mm) is generated. In FIG. 9, reference numerals M1, M2, . . . , and Mm show the electronic mails (generating state) that are generated from the image data PD1, PD2, . . . , and PDm respectively.

Then, when the electronic mail M1 (M2, . . . , Mm) is generated in the electronic mail generating process, the communication connecting process is executed by the TCP for establishing the communication (connection) with the remote device via the LANIF 16 (FIG. 9(D)). When establishing the communication (connection) with the remote device, the communication start command, which starts the communication, (for example, HELO command of the SMTP) is transmitted to the remote device. In FIG. 9, reference numerals C1, C2, . . . , and Cm show the transmission state of the communication start command prior to the transmission of each of the electronic mails M1, M2, . . . , and Mm.

When a connection is established with the destination in the communication connecting process, the electronic mail transmitting process is executed (FIG. 9(E)) for transmitting to the LAN or the Internet, the electronic mail M1 (M2, . . . , Mm) generated in the electronic mail generating process. In FIG. 9, reference numerals MM1, MM2, . . . , and MMm show the transmission state of the electronic mails M1, M2, . . . , and Mm respectively.

Furthermore, each time the transmission of the electronic mail MM1 (MM2, . . . , MMm) in the electronic mail transmitting process ends, the communication disconnecting process is executed for disconnecting the connection established with the remote device (FIG. 9(F)). When disconnecting the connection established with the remote device, an end command for ending the communication (for example, QUIT command of the SMTP) is transmitted to the remote device. In FIG. 9, reference numerals D1, D2, . . . , and Dm show the transmission state of the end command transmitted after the transmission of each of the electronic mails MM1, MM2, . . . , and MMm respectively.

Here, each of the transmitted electronic mails MM1, MM2, . . . , and MMm is one electronic mail, respectively. The remote device receives each of the electronic mails MM1, MM2, . . . , and MMm as separate electronic mail. In accordance with the header and the first main text of each of the electronic mails MM1, MM2, . . . , and MMm, the original document is reconstructed.

A conventional facsimile machine converts into image data from an original document, and then divides the image data and transmits each image data by electronic mails. On the contrary, the facsimile machine according to the present invention carries out the electronic mail transmitting process in parallel with the scanning/encoding process. As a result, the facsimile machine according to the present invention can reduce the period of time from the start of the scanning process of the original document until the end of the transmission of the image data.

Moreover, the destination device that receives the electronic mail transmitted by the facsimile machine according to the present invention can obtain the information of the attached image data by reading the management information described in the electronic mail. For example, from the management information “DOCUMENT-ID” and “BLOCK”, the remote device can learn the electronic mail is and of which original document and an order of the electronic mail among the electronic mails for that original document. From the management information “DOCUMENT-ID” and “NEXT”, the destination device can learn whether or not any further electronic mail will be transmitted. From the management information “DOCUMENT-ID” and “TOTALBLOCK”, the destination device can learn the total number of electronic mails. From the management information “DOCUMENT-ID” and “PAGE-NO”, when the image data of the same original document is divided into a plurality of image data and transmitted, the image can be reconstructed easily based on this information. For example, when receiving electronic mail with the management information “PAGE-NO” is “2-3-0”, it can be confirmed that the second page of the original documents is divided into three electronic mails and transmitted. Then, the electronic mails with the management information “PAGE-NO” is “2-1-1”, “2-2-1” and “2-3-0” can be extracted, and the image of the second page of the original documents can be reconstructed from the image data attached to each of the electronic mails.

Furthermore, by reading the management information “DOCUMENT-ID”, “ERROR” and “RETRANSMISSION” that are described in the electronic mail, the destination device that received the electronic mail transmitted by the facsimile machine according to the present invention can learn the transmission number of the electronic mail with an error and the transmission number of the electronic mail to be retransmitted.

(Second Embodiment)

In the first embodiment, the INFAX 1 established the TCP session with the destination before transmitting each electronic mail, and after transmitting each electronic mail, the INFAX 1 disconnected the TCP session each time. However, in the second embodiment, when receiving the start command for transmitting the original document, the facsimile machine establishes the TCP session with the remote device, and until all electronic mails are transmitted, the INFAX 1 maintains the TCP session.

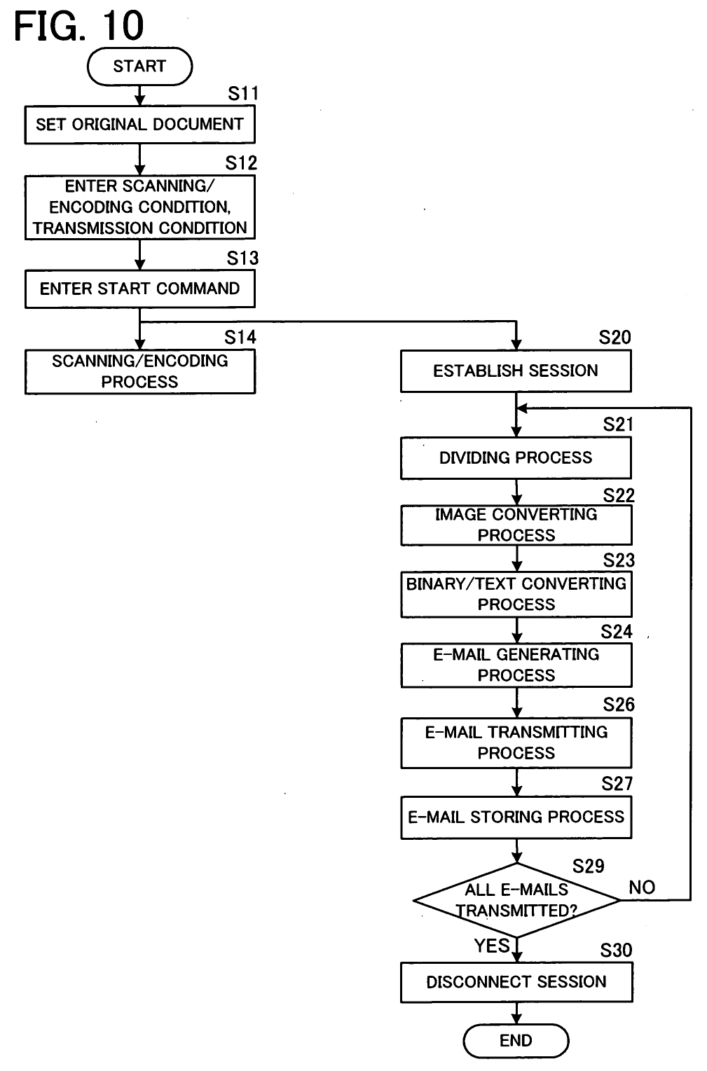

Next, the operation of the facsimile machine according to the second embodiment of the present invention will be described with reference to FIG. 10. FIG. 10 is a flowchart showing the process protocol carried out by the facsimile machine according to the second embodiment of the present invention.

When receiving a start command of the process in step S13, the INFAX 1 establishes a TCP session with the destination (step S20) in parallel with the scanning/encoding process (step S14). When the session is established, the dividing process (step S21), the image converting process (step S22), the binary/text converting process (step S23), the electronic mail generating process (step S24), the electronic mail transmitting process (step S26) and the electronic mail storing process (step S27) are executed.

Then, it is determined whether or not all electronic mails have been transmitted (step S29). When it is determined that all electronic mails have not been transmitted yet (step S29: NO), the process proceeds to step S21 with the session maintained, and the processes of steps S21 through S29 are executed. Meanwhile, when it is determined that all electronic mails have been transmitted (step S29: YES), the session is disconnected (step S30) and the process is ended. Further, when necessary, a connection maintaining command (for example, NO OPeration (NOOP) command of the SMTP) for maintaining the connection with the destination is transmitted to the destination and the session is maintained. As described above, by transmitting the connection maintaining command appropriately and maintaining the connection, a transmission error such as time-out can be prevented from generating. Since other process protocols are the same as those of FIG. 4, same reference numerals are applied to the corresponding parts and the detailed description will be abbreviated.

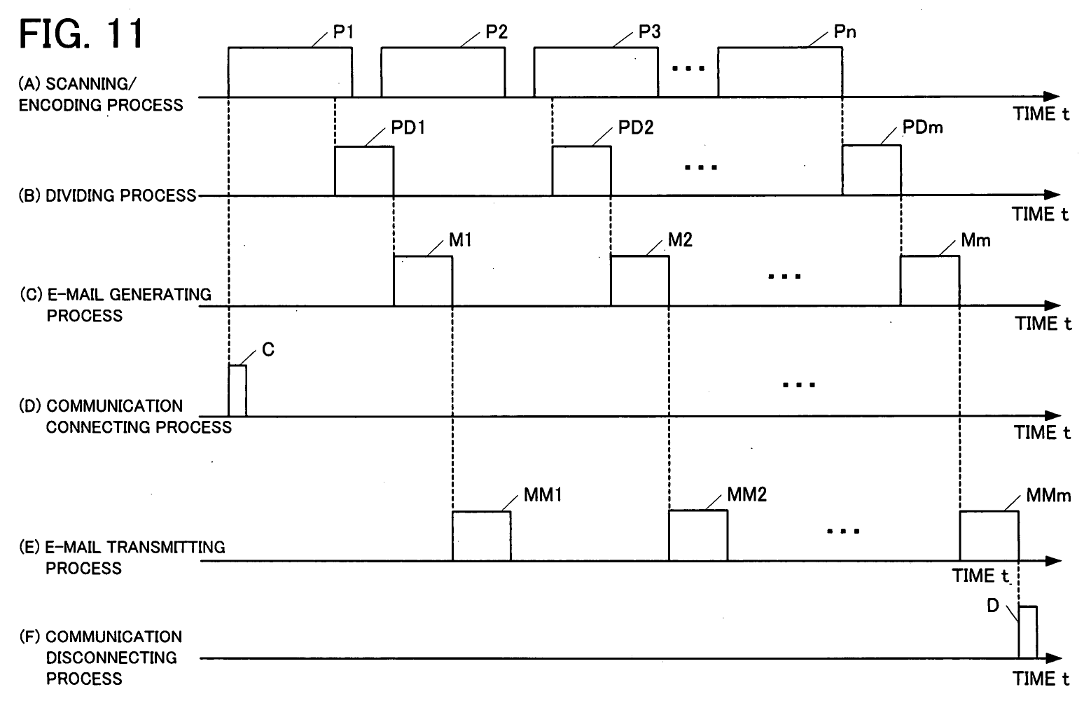

Next, the operation timing of the facsimile machine according to the second embodiment will be described. FIG. 11 shows the state of operation timings of the facsimile machine according to the second embodiment of the present invention. In the second embodiment, the state of the communication connecting process (D) and the state of the communication disconnecting process (F) differ from those of the first embodiment.

That is, only when the first electronic mail M1 is generated in the electronic mail generating process, a communication start command C is transmitted, and the communication connecting process is executed by the TCP for establishing the connection with the remote device via the LANIF 16 (FIG. 11(D)). Then, the electronic mail transmitting process is executed for transmitting on the LAN or the Internet, the electronic mail M1 (M2, . . . , Mm) generated in the electronic mail generating process (FIG. 11(E)). Furthermore, only when the transmission of the last electronic mail MMm in the electronic mail transmitting process is completed, the communication disconnecting process is executed for disconnecting the connection with the remote device by transmitting an end command D (FIG. 11 (F)). In other words, when the transmission of the electronic mails MM1, MM2, . . . , and MMm-1 is completed, the communication disconnecting process is not executed. The state of the other operation timings are the same as those shown in FIG. 9. Therefore, same reference numerals are applied to the corresponding parts and the detailed description will be abbreviated.

In other words, the facsimile machine of the second embodiment establishes the TCP session with the remote device and then executes various other processes. Then, until transmitting all electronic mails, the TCP session is maintained. Therefore, compared with the process protocol that establishes and disconnects the session with the remote device each time each electronic mail is transmitted, the period of time from the start of the scanning of the original document until the end of the transmission of the image data can be reduced.

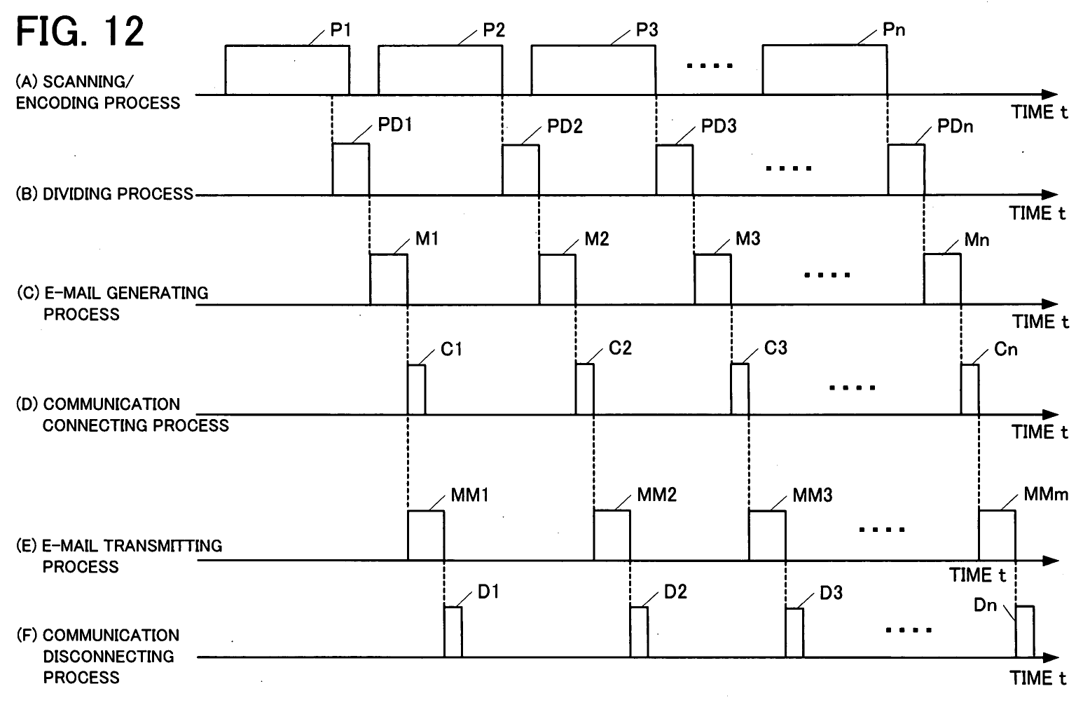

Further, in each of the embodiments, each time the amount of the image data exceeds the prescribed amount, the image data is divided. However, as shown in FIG. 12, the image data can be divided for each page of the original documents, each of the divided image data can be attached to electronic mail, and the electronic mails can be transmitted to the remote device. In other words, the dividing process (FIG. 12(B)) is executed for dividing the image data (encoded data) scanned in the scanning/encoding process into the image data PD1 (PD2, . . . , PDn) for each page of the original documents. In FIG. 12, reference numerals PD1, PD2, . . . , and PDn show the image data divided first, second, . . . , and n-th respectively, in other words, the image data of the first page P1, the second page P2, . . . , and the n-th page Pn of the original documents. The state of the other operation timings are the same as those shown in FIG. 9. Therefore, same reference numerals are applied to the corresponding parts and the detailed description will be abbreviated.

What is claimed is:

1. A facsimile machine comprising:
means for scanning an original document to generate image data;
means for detecting whether an amount of the image data exceeds a prescribed amount;
means for dividing the image data in parallel with the scanning of the original document each time the amount of the image data is detected to exceed the prescribed amount; and
means for transmitting each divided image data by electronic mail.

2. The facsimile machine according to claim 1, wherein the means for transmitting further includes means for establishing a connection with a remote device when the scanning of the original document is started.

3. The facsimile machine according to claim 2, wherein the means for transmitting further includes means for maintaining the connection with the remote device until all divided image data are transmitted.

4. The facsimile machine according to claim 1, further comprising:
means for storing the electronic mail;
means for receiving information regarding reception of the electronic mail from the remote device; and
means for erasing the electronic mail from the means for storing when it is determined that the remote device received the electronic mail normally in accordance with the information received from the remote device.

5. A facsimile machine comprising:
means for scanning an original document to generate image data;
means for detecting whether an amount of the image data exceeds a prescribed amount;
means for dividing the image data in parallel with the scanning of the original document each time the amount of the image data is detected to exceed the prescribed amount;
means for transmitting each divided image data by electronic mail; and
means for stopping the transmission of the electronic mail when an error generates in the means for generating.

6. A facsimile machine comprising:
means for scanning an original document to generate image data;
means for detecting whether an amount of the image data exceeds a prescribed amount;
means for dividing the image data in parallel with the scanning of the original document each time the amount of the image data is detected to exceed the prescribed amount;
means for transmitting each divided image data by electronic mail; and
means for stopping the scanning of the original document when an error generates in the means for transmitting.

7. The facsimile machine according to claim 6, further comprising:
means for storing the electronic mail; and
means for retransmitting the electronic mail by outputting the electronic mail from the means for storing when it is determined that the electronic mail can be retransmitted based on contents of the error.

8. The facsimile machine according to claim 6, further comprising:
means for stopping the scanning of the original document and the transmission of the electronic mail when it is determined that the electronic mail cannot be retransmitted based on contents of the error.

9. A facsimile machine comprising:
means for scanning an original document to generate image data;
means for detecting whether an amount of the image data exceeds a prescribed amount;
means for dividing the image data in parallel with the scanning of the original document each time the amount of the image data is detected to exceed the prescribed amount;
means for transmitting each divided image data by electronic mail;
means for providing the electronic mail with information regarding an error when detecting the error in the transmitted electronic mail; and
means for retransmitting the electronic mail.

10. The facsimile machine according to claim 9, further comprising:
means for storing the electronic mail; and
means for retransmitting the electronic mail by outputting the electronic mail from the means for storing when it is determined that the electronic mail can be retransmitted based on contents of the error.

11. The facsimile machine according to claim 9, further comprising:
means for stopping the scanning of the original document and the transmission of the electronic mail when it is determined that the electronic mail cannot be retransmitted based on the contents of the error.

12. A facsimile machine comprising:
means for scanning an original document to generate image data;
means for detecting whether an amount of the image data exceeds a prescribed amount;
means for dividing the image data in parallel with the scanning of the original document each time the amount of the image data is detected to exceed the prescribed amount;
means for transmitting each divided image data by electronic mail; and
means for providing the electronic mail with information indicating a transmission number of the electronic mail.

13. The facsimile machine according to claim 12, further comprising:
means for providing the electronic mail with information indicating whether subsequent electronic mail will be transmitted.

14. The facsimile machine according to claim 12, further comprising:
means for providing the electronic mail with information indicating a total number of the electronic mails.

15. The facsimile machine according to claim 12, further comprising:
means for providing the electronic mail with page information of the original document.
